(19) United States
(12) Patent Application Publication
(10) Pub. No.: US 2017/0349184 A1
(43) Pub. Date: Dec. 7, 2017

(54) SPEECH-BASED GROUP INTERACTIONS IN AUTONOMOUS VEHICLES

(71) Applicant: GM Global Technology Operations LLC, Detroit, MI (US)

(72) Inventors: Eli Tzirkel-Hancock, RA'ANANA (IL); Ilan Malka, TEL AVIV (IL); Ute Winter, PETACH TIQWA (IL)

(21) Appl. No.: 15/615,492

(22) Filed: Jun. 6, 2017

Related U.S. Application Data
(60) Provisional application No. 62/346,142, filed on Jun. 6, 2016.

(51) Int. Cl. B60W 50/08; G05D 1/00; G05D 1/02; G06Q 50/30; G06Q 50/00

(52) U.S. Cl. CPC B60W 50/08; G05D 1/0088; G05D 1/0221; B60W 2540/02; G06Q 50/01; G06Q 50/30; G05D 2201/0212

(57) ABSTRACT

A system, for determining autonomous-driving-vehicle actions associated with a group of autonomous-driving-vehicle passengers. The system includes an input-interface module that, when executed by a processing unit, obtains, from at least a first autonomous-driving-vehicle passenger of the group of autonomous-driving-vehicle passengers, an autonomous-vehicle-passenger input relating to the group. The system also includes at least one collaboration module. Example collaboration modules include an extra-vehicle-collaboration module that, when executed by the processing unit, determines, based on the autonomous-vehicle-passenger input, an extra-vehicle function to be performed at least in part outside of the vehicle. Another example collaboration module is an intra-vehicle-collaboration module that, when executed by the processing unit, determines, based on the autonomous-vehicle-passenger input, an intra-vehicle function to be performed at the vehicle.

### TECHNICAL FIELD

The present disclosure relates generally to autonomous vehicles and, more particularly, to systems for interacting intelligently by speech with an autonomous-vehicle passenger group.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

While availability of autonomous-driving-capable vehicles is on the rise, users' familiarity and comfort with autonomous-driving functions will not necessarily keep pace. User comfort with the automation is an important aspect in overall technology adoption and user experience.

Also, with highly automated vehicles expected to be commonplace in the near future, a market for fully-autonomous taxi services and shared vehicles is developing. In addition to becoming familiar with the automated functionality, customers interested in these services will need to become accustomed to be driven by a driverless vehicle that is not theirs, and in some cases along with other passengers, whom they may not know.

Uneasiness with automated-driving functionality, and possibly also with the shared-vehicle experience, can lead to reduced use of the autonomous driving capabilities, such as by the user not engaging, or disengaging, autonomous-driving operation, or not commencing or continuing in a shared-vehicle ride. In some cases, the user continues to use the autonomous functions, whether in a shared vehicle, but with a relatively low level of satisfaction.

An uncomfortable user may also be less likely to order the shared vehicle experience in the first place, or to learn about and use more-advanced autonomous-driving capabilities, whether in a shared ride or otherwise.

Levels of adoption can also affect marketing and sales of autonomous-driving-capable vehicles. As users' trust in autonomous-driving systems and shared-automated vehicles increases, the users are more likely to purchase an autonomous-driving-capable vehicle, schedule an automated taxi, share an automated vehicle, model doing the same for others, or expressly recommend that others do the same.

### SUMMARY

In one aspect, the present technology relates to a system, for determining autonomous-driving-vehicle actions associated with a group of autonomous-driving-vehicle passengers. The system includes an input-interface module that, when executed by a processing unit, obtains, from at least a first autonomous-driving-vehicle passenger of the group of autonomous-driving-vehicle passengers, an autonomous-vehicle-passenger input relating to the group. The system also includes at least one collaboration module. Example collaboration modules include an extra-vehicle-collaboration module that, when executed by the processing unit, determines, based on the autonomous-vehicle-passenger input, an extra-vehicle function to be performed at least in part outside of the vehicle. Another example collaboration module is an intra-vehicle-collaboration module that, when executed by the processing unit, determines, based on the autonomous-vehicle-passenger input, an intra-vehicle function to be performed at the vehicle.

In another aspect, the technology relates to a system for determining autonomous-driving-vehicle actions associated with a group of autonomous-driving-vehicle passengers. The system includes a hardware-based processing unit and a non-transitory computer-readable storage device. The device includes an input-interface module that, when executed by the processing unit, obtains, from at least one autonomous-driving-vehicle of the group of autonomous-driving-vehicle passengers, an autonomous-vehicle-passenger input relating to or affecting the group.

The device also includes one or both of an (i) intra-vehicle-collaboration module that, when executed by the processing unit, determines, based on the autonomous-vehicle-passenger input, an appropriate vehicle function to be performed at least in at the vehicle, and (ii) an extra-vehicle-collaboration module that, when executed by the processing unit, determines, based on the autonomous-vehicle-passenger input, an appropriate function to be performed at least in part outside of the vehicle.

The extra-vehicle-collaboration module and/or the intra-vehicle collaboration module, when executed by the processing unit, determines the appropriate vehicle function based on the autonomous-vehicle-passenger input and passenger-group-profile data.

The system further includes a group-profiles learning module that, when executed by the processing unit, determines the group-profile data. The group-profiles learning module, when executed by the processing unit, determines the group-profile data based on passenger communication, passenger behavior, or other activity of a passenger of the group of passengers.

The extra-vehicle-collaboration module and/or the intra-vehicle collaboration module, when executed by the processing unit, determines the appropriate vehicle function based on the autonomous-vehicle-passenger input and passenger-profile data.

The system further includes a passenger-profiles learning module that, when executed by the processing unit, determines the passenger-profile data.

The passenger-profiles learning module, when executed by the processing unit, determines the passenger-profile data based on passenger communication, passenger behavior, or other activity of a passenger of the group of passengers.

The system in various embodiments also includes an extra-vehicle output module that, when executed by the processing unit, initiates or implements the vehicle function determined.

In another aspect, the technology includes a non-transitory computer-readable storage component according to any of the embodiments disclosed herein.

In still other aspects, the technology includes algorithms for performing any of the functions recited herein, and corresponding processes, including the functions performed by the structure described.

Other aspects of the present technology will be in part apparent and in part pointed out hereinafter.

### DESCRIPTION OF THE DRAWINGS

FIG. 1 illustrates schematically an example vehicle of transportation, with local and remote computing devices, according to embodiments of the present technology.

FIG. 2 illustrates schematically more details of an example vehicle computer of FIG. 1 in communication with the local and remote computing devices.

FIG. 3 shows another view of the vehicle, emphasizing example vehicle computing components.

FIG. 4 shows interactions between the various components of FIG. 3, including with external systems.

FIG. 5 shows schematically an example arrangement including other select components of an architecture of a subject autonomous vehicle, and select corresponding components of another autonomous vehicle.

FIG. 6 shows a flow chart including operations for effecting a privacy mode regarding users of a shared ride based on user speech.

FIG. 7 shows a flow chart including operations for effecting a conference call amongst users of a shared ride based on user speech.

FIG. 8 shows a flow chart including operations supporting users of a shared ride affecting ride itinerary by speech.

The figures are not necessarily to scale and some features may be exaggerated or minimized, such as to show details of particular components.

The figures show example implementations, and the invention is not limited to the implementations illustrated.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

I. Technology Introduction

The present disclosure describes, by various embodiments, systems for interacting intelligently with autonomous-vehicle passengers, by speech regarding a passenger group. One or more of the operations can be performed at any of various apparatus, such as the autonomous vehicle, other vehicles, a user mobile device, and a remote computing system such as a cloud server.

Operations are in some implementations performed with consideration given to at least one passenger profile, containing preferences expressed explicitly by the passenger and/or generated by an acting apparatus (e.g., vehicle or remote server) based on interactions with the passenger, such as based on passenger behavior, selections, or other activity or relevant conditions.

In various embodiments, the technology involves determining passenger needs and preferences as they pertain to a group of autonomous-vehicle passengers, whether they are all presently in the autonomous-driving vehicle, or whether in the same vehicle.

In various embodiments, the technology involves determining responsive actions, as they pertain to a group of autonomous-vehicle passengers, including controlling autonomous-driving functions, vehicle infotainment settings, or delivering messages to people in the group, by electronic communications (e.g., email, internet (app) communications over the Internet, etc.) or by way of one or more vehicle or mobile-device human-machine interfaces (HMIs).

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trolleys, trains, the like, and other.

While select examples of the present technology describe autonomous vehicles, the technology is not limited to use in autonomous vehicles (fully or partially autonomous), or to times in which an autonomous-capable vehicle is being driven autonomously. References herein to characteristics of a passenger, and communications provided for receipt by a passenger, for instance, should be considered to disclose analogous implementations regarding a vehicle driver during manual vehicle operation. During fully autonomous driving, the ‘driver’ is considered a passenger.

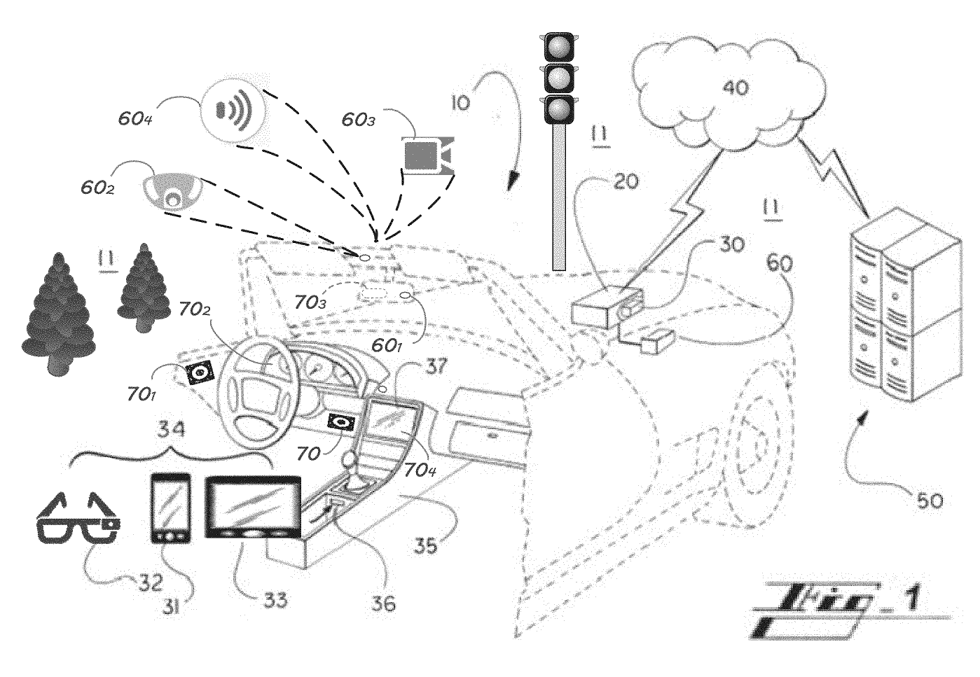

II. Host Vehicle—FIG. 1

Turning now to the figures and more particularly the first figure, FIG. 1 shows an example host structure or apparatus 10 in the form of a vehicle.

The vehicle 10 includes a hardware-based controller or controller system 20. The hardware-based controller system 20 includes a communication sub-system 30 for communicating with mobile, portable, or local computing devices 34 and/or external networks 40.

By the external networks 40, such as the Internet, a local-area, cellular, or satellite network, vehicle-to-vehicle, pedestrian-to-vehicle or other infrastructure communications, etc., the vehicle 10 can reach mobile or local systems 34 or remote systems 50, such as remote servers.

Example mobile or local devices 34 include a passenger smartphone 31, a passenger wearable device 32, and a passenger tablet computer, and are not limited to these examples. Example wearables 32 include smart-watches, eyewear, and smart-jewelry, such as earrings, necklaces, and lanyards. Another example mobile device is a USB mass storage device (not shown).

Another example mobile or local device is an on-board device (OBD) (not shown in detail), such as a wheel sensor, a brake sensor, an accelerometer, a rotor-wear sensor, throttle-position sensor, steering-angle sensor, revolutions-per-minute (RPM) indicator, brake-force sensors, other vehicle state or dynamics-related sensor for the vehicle, with which the vehicle is retrofitted with after manufacture. The OBD(s) can include or be a part of the sensor sub-system referenced below by numeral 60.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 include a central console, a dashboard, and an instrument panel. The mounting structure 35 includes a plug-in port 36—a USB port, for instance—and a visual display 37, such as a touch-sensitive, input/output, human-machine interface (HMI).

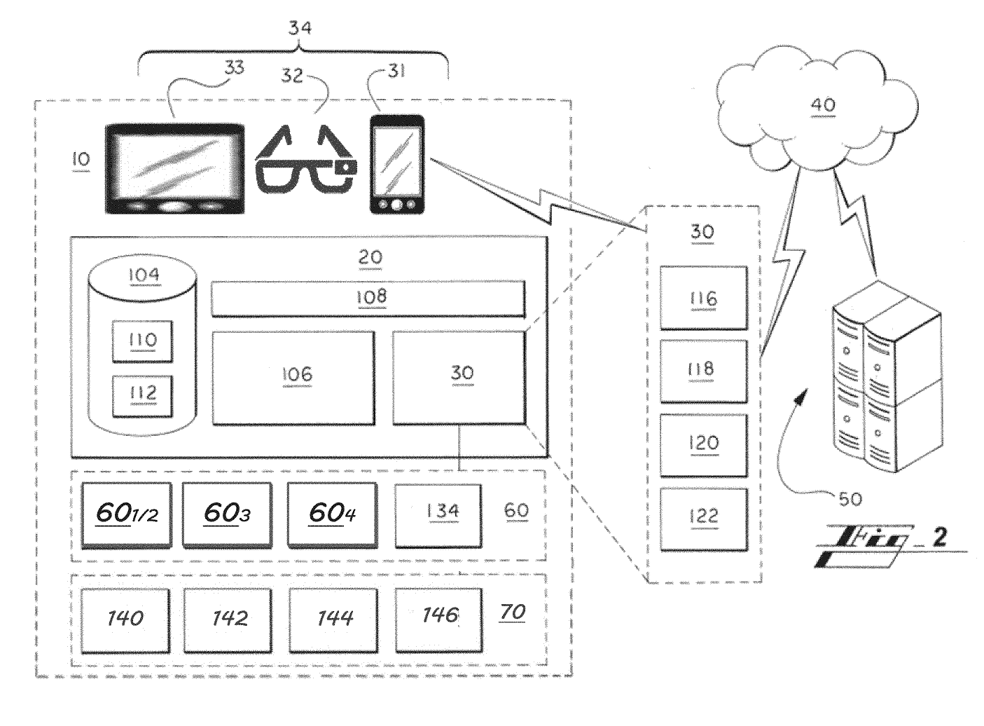

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (60₁, 60₂, etc.) are also shown.

Sensor data relates to features such as vehicle operations, vehicle position, and vehicle pose, passenger characteristics, such as biometrics or physiological measures, and environmental-characteristics pertaining to a vehicle interior or outside of the vehicle 10.

Example sensors include a camera 60₁ positioned in a rear-view mirror of the vehicle 10, a dome or ceiling camera 60₂ positioned in a header of the vehicle 10, a world-facing camera 60₃ (facing away from vehicle 10), and a world-facing range sensor 60₄. Intra-vehicle-focused sensors 60₁, 60₂, such as cameras, and microphones (and associated componentry, such as speech recognition structure), are configured to sense presence of people, activities or people, or other cabin activity or characteristics. The sensors can also be used for authentication purposes, in a registration or re-registration routine. This subset of sensors are described more below.

World-facing sensors 60₃, 60₄ sense characteristics about an environment 11 comprising, for instance, billboards, buildings, other vehicles, traffic signs, traffic lights, pedestrians, etc.

The OBDs mentioned can be considered as local devices, sensors of the sub-system 60, or both in various embodiments.

Local devices 34 (e.g., passenger phone, passenger wearable, or passenger plug-in device) can be considered as sensors 60 as well, such as in embodiments in which the vehicle 10 uses data provided by the local device based on output of a local-device sensor(s). The vehicle system can use data from a passenger smartphone, for instance, indicating passenger-physiological data sensed by a biometric sensor of the phone.

The vehicle 10 also includes cabin output components 70, such as audio speakers 70₁, and an instruments panel or display 70₂. The output components may also include dash or center-stack display screen 70₃, a rear-view-mirror screen 70₄ (for displaying imaging from a vehicle aft/backup camera), and any vehicle visual display device 37.

III. On-Board Computing Architecture—FIG. 2

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In various embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

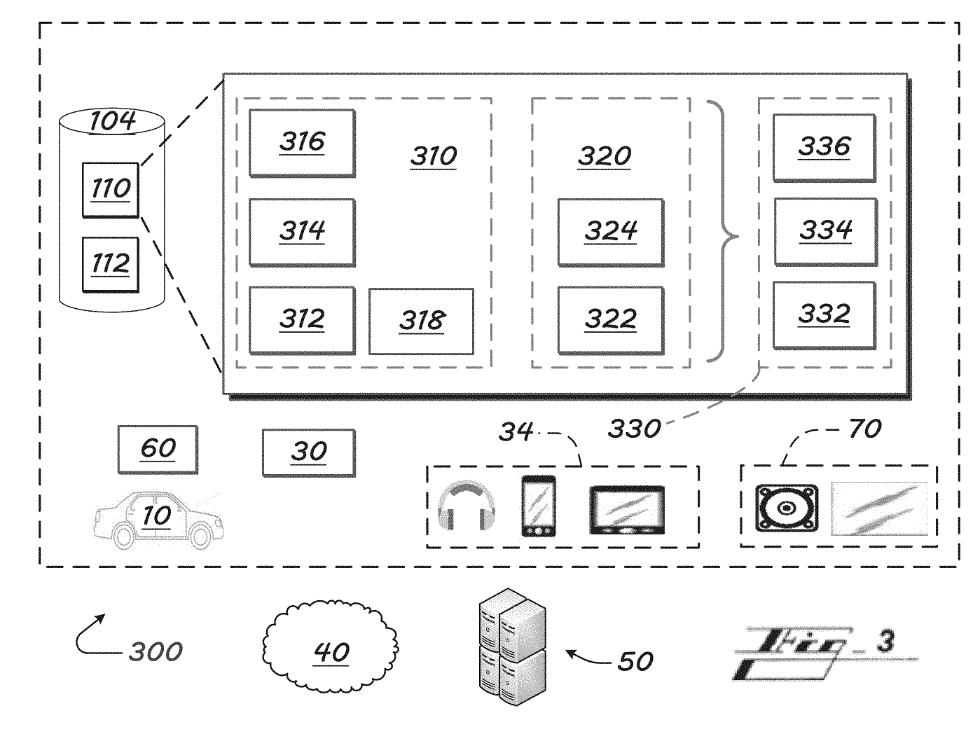

The data storage device 104 includes one or more storage modules 110 storing computer-readable code or instructions executable by the processing unit 106 to perform the functions of the controller system 20 described herein. The modules and functions are described further below in connection with FIGS. 3-5.

The data storage device 104 in various embodiments also includes ancillary or supporting components 112, such as additional software and/or data supporting performance of the processes of the present disclosure, such as one or more passenger profiles or a group of default and/or passenger-set preferences.

As provided, the controller system 20 also includes a communication sub-system 30 for communicating with local and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in various embodiments configured to facilitate communications between the controller system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While local devices 34 are shown within the vehicle 10 in FIGS. 1 and 2, any of them may be external to the vehicle and in communication with the vehicle.

Example remote systems 50 include a remote server (for example, application server), or a remote data, customer-service, and/or control center. A passenger computing or electronic device 34, such as a smartphone, can also be remote to the vehicle 10, and in communication with the sub-system 30, such as by way of the Internet or other communication network 40.

An example control center is the OnStar® control center, having facilities for interacting with vehicles and passengers, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, passenger characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 60₄, such as radar or sonar, directed away from the vehicle, such as for supporting autonomous driving. In some embodiments a camera is used to sense range.

Visual-light cameras 60₃ directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 60₃ and the range sensor 60₄ may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 60₄ may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors (60₁, 60₂, etc.) configured and arranged (e.g., positioned and fitted in the vehicle) to sense activity, people, cabin environmental conditions, or other features relating to the interior of the vehicle. Example cabin sensors (60₁, 60₂, etc.) include microphones, in-vehicle visual-light cameras, seat-weight sensors, passenger salinity, retina or other passenger characteristics, biometrics, or physiological measures, and/or the environment about the vehicle 10.

The cabin sensors (60₁, 60₂, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for the camera(s) are indicated in FIG. 1 by reference numeral 60₁, 60₂, etc.—on at rear-view mirror and one at the vehicle header.

Other example sensor sub-systems 60 include dynamic vehicle sensors 134, such as an inertial-momentum unit (IMU), having one or more accelerometers, a wheel sensor, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any known sensor for measuring an environment of the vehicle, including those mentioned above, and others such as a precipitation sensor for detecting whether and how much it is raining or snowing, a temperature sensor, and any other.

Sensors for sensing autonomous-vehicle-passenger characteristics include any biometric or physiological sensor, such as a camera used for retina or other eye-feature recognition, facial recognition, or fingerprint recognition, a thermal sensor, a microphone used for voice or other passenger recognition, other types of passenger-identifying camera-based systems, a weight sensor, breath-quality sensors (e.g., breathalyzer), a passenger-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and passenger-temperature, a sensor measuring salinity level, the like, or other.

Passenger-vehicle interfaces, such as a touch-sensitive display 37, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to audio speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

IV. Additional Vehicle Components—FIG. 3

FIG. 3 shows an alternative view 300 of the vehicle 10 of FIGS. 1 and 2 emphasizing example memory components, and showing associated devices.

As mentioned, the data storage device 104 includes one or more modules 110 for performance of the processes of the present disclosure. and the device 104 may include ancillary components 112, such as additional software and/or data supporting performance of the processes of the present disclosure. The ancillary components 112 can include, for example, additional software and/or data supporting performance of the processes of the present disclosure, such as one or more passenger profiles or a group of default and/or passenger-set preferences.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function.

Example modules 110 shown include:
Input Group 310
   an input-interface module 312;
   a database module 314;
   a passenger-profiles learning module 316; and
   a group-profiles learning module 318.
Collaboration Activity Group 320
   an intra-vehicle-collaboration module 322; and
   an extra-vehicle-collaboration module 324.
Collaboration Output Group 330
   an intra-vehicle output module 332; and
   an extra-vehicle output module 334; and
   a profiles-update module 336.

Other vehicle components shown in FIG. 3 include the vehicle communications sub-system 30 and the vehicle sensor sub-system 60. These sub-systems act at least in part as input sources to the modules 110, and particularly to the input interface module 302. Example inputs from the communications sub-system 30 include identification signals from mobile devices, which can be used to identify or register a mobile device, and so the corresponding passenger, to the vehicle 10, or at least preliminarily register the device/passenger to be followed by a higher-level registration.

Example inputs from the vehicle sensor sub-system 60 include and are not limited to:
bio-metric sensors providing bio-metric data regarding vehicle occupants, such as facial features, voice recognition, heartrate, salinity, skin or body temperature for each occupant, etc.;
vehicle-occupant input devices (human-machine interfaces (HMIs), such as a touch-sensitive screen, buttons, knobs, microphones, and the like;
cabin sensors providing data about characteristics within the vehicle, such as vehicle-interior temperature, in-seat weight sensors, and motion-detection sensors;
environment sensors providing data bout conditions about a vehicle, such as from external camera and distance sensors (e.g., LiDAR, radar); and
Sources separate from the vehicle 10, such as local devices 34, devices worn by pedestrians, other vehicle systems, local infrastructure (local beacons, cellular towers, etc.), satellite systems, and remote systems 34/50, providing any of a wide variety of information, such as passenger-identifying data, passenger-history data, passenger selections or passenger preferences contextual data (weather, road conditions, navigation, etc.), program or system updates—remote systems can include, for instance, applications servers corresponding to application(s) operating at the vehicle 10 and any relevant passenger devices 34, computers of a passenger or supervisor (parent, work supervisor), vehicle-operator servers, customer-control center system, such as systems of the OnStar ® control center mentioned, or a vehicle-operator system, such as that of a taxi company operating a fleet of which the vehicle 10 belongs, or of an operator of a ride-sharing service.

The view also shows example vehicle outputs 70, and passenger devices 34 that may be positioned in the vehicle 10. Outputs 70 include and are not limited to:
vehicle speakers or audio output;
vehicle screens or visual output;
vehicle-dynamics actuators, such as those affecting autonomous driving (vehicle brake, throttle, steering);
vehicle climate actuators, such as those controlling HVAC system temperature, humidity, zone outputs, and fan speed(s); and
local devices 34 and remote systems 34/50, to which the system may provide a wide variety of information, such as passenger-identifying data, passenger-biometric data, passenger-history data, contextual data (weather, road conditions, etc.), instructions or data for use in providing notifications, alerts, or messages to the passenger or relevant entities such as authorities, first responders, parents, an operator or owner of a subject vehicle 10, or a customer-service center system, such as of the OnStar® control center.

System output can be effected by any of various non-vehicle devices, such as by sending communications between users using the internet or phone system.

The modules, sub-modules, and their functions are described more below.

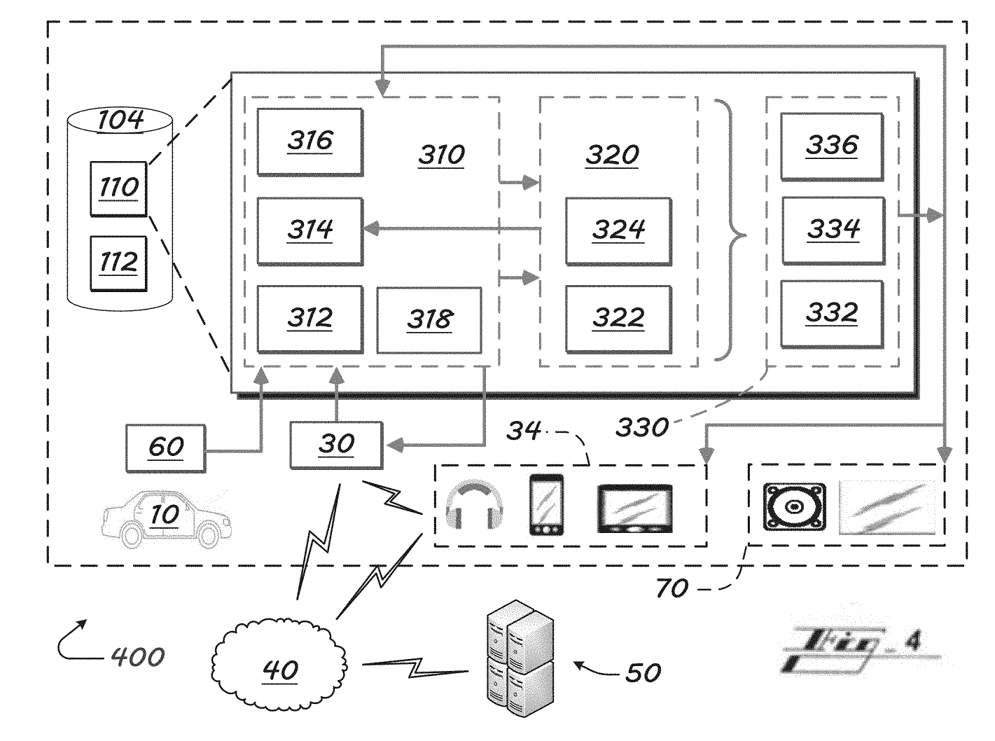

### V. First Example Algorithms and Processes—FIG. 4

### V.A. Introduction

FIG. 4 shows an example algorithm, represented schematically by a process flow 400, according to embodiments of the present technology. Though a single process flow is shown for simplicity, any of the functions or operations can be performed in one or more or processes, routines, or sub-routines of one or more algorithms, by one or more devices or systems.

It should be understood that the steps, operations, or functions of the process 400 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated process 400 can be ended at any time.

In certain embodiments, some or all operations of the process 400 and/or substantially equivalent operations are performed by a computer processor, such as the hardware-based processing unit 106, executing computer-executable instructions stored on a non-transitory computer-readable storage device, such as any of the data storage devices 104, or of a mobile device, for instance, described above.

### V.B. System Components and Functions

FIG. 4 shows the components of FIG. 3 interacting according to various exemplary algorithms and process flows.

### V.B.i. Input Group 310

The input group includes the input-interface module 312, the database module 314, the passenger-profiles learning module 316, and the group-profiles learning module 318.

### V.B.i.a. General Input Functions

The input-interface module 312, executed by a processor such as the hardware-based processing unit 106, receives any of a wide variety of input data or signals, including from the sources described in the previous section (IV.). Inputs sources include vehicle sensors 60 and local or remote devices 34, 50 via the vehicle communication sub-system 30. Inputs also include a vehicle database, via the database module 304.

Data received can include or indicate, and are not limited to:
i. passenger profile data indicating preferences and historic activity of an autonomous-vehicle passenger or passengers, received from a remote database or server 50;
ii. passenger communication input, via any modality, such as speech via microphone, button, switch, or touch-sensitive screen, gestures via camera, etc.;
iii. input from passengers not in the autonomous vehicle 10, such as persons dropped off recently or to be picked up;
iv. input from other persons, such as friends, supervisor, colleague, parents, other relatives;
v. passenger adjustments made or requested for vehicle systems (e.g., “please speed up,” or “please start a group game between us three.”);
vi. autonomous-vehicle cabin climate conditions (temp, humidity, etc.);
vii. autonomous-vehicle location (e.g., GPS) data;
viii. extra-vehicle climate conditions;
ix. map or navigation information;
x. autonomous-vehicle itinerary data;
xi. data identifying passengers, such as an autonomous-vehicle manifest for the ride, for the day, etc., which may be part of the itinerary data and may include identifying information such as name for each passenger, or biometric or physiological characteristics of the passengers (for retina identification, for instance), mobile phone identification information - Based upon the latter, the system can authenticate passengers via their mobile device 34 communicating with the vehicle 10 using a short-range protocol. identification information can be part of respective passenger profiles, and stored at the memory 104 of the vehicle 10 by the database module 314;
xii. Vehicle systems states, such as autonomous-vehicle dynamics statuses (speed, etc.), HVAC states (fan setting, temp setting, etc.), climate-affecting system (window and moon-roof positions, seat heat/cool), and infotainment system states (volume, channel, etc.).

Data received is stored at the memory 104 via the database module 314, and is accessible by other modules. Stored profile-related data, for instance, can be accessed by and, in embodiments, updated by, the passenger-profiles learning module 316 and the group-profiles learning module 318.

### V.B.i.b. Learning Functions

The passenger-profiles learning module 316 and group-profiles learning module 318 use any of a wide variety of inputs to determine system output. The passenger-profiles learning module 316 is configured to personalize the system to one or more passengers. The group-profiles learning module 318 is configured to personalize the system to one or more groups.

Groups can be established in the system in any of a variety of ways. In one implementation, passengers can ask or instruct the system to form a group in the system for select passengers. Such input can be provided by a passenger or group by any modality, such as to the vehicle, via a personal device 34, home computer, etc. In various implementations, the system determines that a group should be formed based on activity, such as determining that every Friday night the same group of five friends share an automated ride to and from their favorite restaurant. This learning function may be performed by the group-profiles learning module 318.

Regarding the passenger-profiles learning module 316, passenger characteristics that can be learned include and are not limited to passenger-preferred driving style, routing, infotainment settings, HVAC settings, etc.

The configuration of the passenger-profiles learning module 316 and the group-profiles learning module 318 in various embodiments includes, respective or common, artificial intelligence, computational intelligence heuristic structures, or the like. Inputs can include data indicating present, or past or prior, passenger or group behavior, for instance.

Prior activity can include past actions of one or more passenger or a group, in a prior ride in the vehicle 10 or another vehicle, such as statements from the passenger, members of a group, questions from the passenger or passenger of a group, or vehicle-control actions, as a few examples.

As an example learning scenario affecting a passenger profile, if an autonomous-vehicle passenger sitting in a third row of the vehicle 10 alone asks the vehicle 10 to fade music playing more or fully toward forward vehicle speakers on repeated occasions, the passenger-profiles learning module 316, having access to present and historic data indicating the requests (e.g., data from the vehicle 10, the same music-fad requests in other vehicles, remote systems, local device (e.g., companion apps)), can deduce a passenger preference for low music, or fading music to the front, etc.

Data indicating the new association is stored at the corresponding passenger profile in the vehicle memory 104 via the database module 314, and the system can implement the preference on future occasions. The profile update, or entire updated profile, can be shared or synchronized to other local or remote sources, such as a companion application (ride-sharing or an autonomous shared-vehicle or taxi app, for instance) on a passenger mobile device 34 or a remote server or computer system 50, such as a shared-ride or taxi system or customer-service system such as the OnStar® system.

As an example learning scenario affecting a passenger-group profile, if a certain combination of passengers, on multiple trips to dinner together asks or instructs the vehicle to institute a group game in the vehicle 10, such as via touch-sensitive screens positioned in front of each passenger, the passenger-group-profiles learning module 318, having access to present and historic data indicating the requests (e.g., whether data from the vehicle 10, the same game requests in other vehicles, remote systems, local device (e.g., companion apps)), can deduce a passenger-group preference for playing the game when on a ride at that time of week to that destination, or when the passenger group is ever riding together, or some other related scope. Data indicating the new association is stored at the corresponding passenger-group profile in the vehicle memory 104 via the database module 314, and the system can implement the preference on future occasions. The profile update, or entire updated profile, can be shared or synchronized to other local or remote sources, such as a companion application (ride-sharing or an autonomous shared-vehicle or taxi app, for instance) of passenger mobile device(s) 34 or remote server or computer system 50, such as a shared-ride or taxi system or customer-service system such as the OnStar® system.

Output from the passenger-profiles learning module 316 and the group-profiles learning module 318 can be used as input to the modules of the collaboration activity group 320. For instance, if the passenger of the first example above gets in the vehicle 10 while music is playing from each vehicle speaker, a module of the activity group (e.g., intra-vehicle collaboration module 412) can communicate to the subject passenger or all passengers—to advise, or seek their agreement, for instance, or can just implement the adjustment.

By the learning functions, the vehicle is customized better to passenger and passenger groups, and the passenger, passenger-group experience is improved for various reasons. The passengers are more comfortable, and experience less or no stress, as the vehicle makes more decisions based on determined passenger or group preferences. The passengers are also relieved of having to determine how to advise the vehicle that the passenger or group wants the vehicle to make a maneuver or other change to improve the passenger(s) experience. They need not, for instance, consider which button to press, or which pre-set control wording to say—for instance, “car, please play our favorite morning news”.

In a contemplated embodiment, passenger-profiles learning module 316 and passenger-group profiles learning module 318 are also configured to make associations between passenger behaviors besides speech, such as gestures, and passenger desires or preferences. A user sighing deeply, or covering their eyes with a hand, sensed by a vehicle interior camera, can be interpreted to express stress and, based on the circumstance, an implicit desire to change the situation for the passenger as it relates to the group (e.g., a sigh by the third-row passenger who does not want the music from the third-row speakers) or for the group (e.g., the vehicle noticing existing passengers hugging a new passenger to a ride, the system may determine the gestures to indicate that the passengers are a group (e.g., family or friends)).

### V.B.i.c. Input Functions Summary

In various embodiments, the system is configured to receive and store passenger and group preferences provided to the system expressly by the passengers.

The profile for each passenger can include passenger-specific preferences communicated to the system by the passenger, such as via a touch-screen or microphone interface.

All or select components of the passenger or group profiles can be stored at the memory 104 via the database module 314, and at other local or remote devices, such as at a user device 34, or customer-service center computer or server 50.

Input group modules can interact with each other in a variety of ways to perform the functions described herein. Output of the input and learning modules may be stored via the database module, for instance, and the learning module considers data from the database module.

Input-group data is passed on, after any formatting, conversion, or other processing at the input module 302, to the collaboration activity group 320.

### V.B.ii. Collaboration Activity Group 320

Turning further to the collaboration activity group 320, the modules thereof determine manners to perform various tasks based on input such as passenger input, passenger and group profile data, and context. Context data can indicate any of a wide variety of factors, such as a present vehicle state or mode, present autonomous-driving operations conditions (speed, route, etc.), cabin climate, weather, road conditions, or other.

The primary user input described herein includes speech or other verbal input, including utterances. The technology is not limited to using verbal input, however, as referenced above.

A group can be any associated passengers, even if they do not know each other, and even if not all in the vehicle 10 together, such as by the passengers sharing an itinerary—e.g., the vehicle planned to transport the passengers on the same vehicle trip on a day.

Collaboration actions determined affect a group of passengers in any of a variety of ways. The actions can affect the group, whether each of the members is presently in a vehicle. An action can include including the passengers of the group in an activity, such as a game or infotainment activity, for instance. Or the action can include excluding one or more passengers of the group from an activity, such as by limiting communication or information to only two of four passengers of a group, even if the passengers do not know each other—such as if the two requested some private communications from the others, such as via screens dedicated to the two passengers.

While the group activities determined at the activity group 320 can include any of a wide variety of activities affecting a group, in various embodiments the activities can be divided into two primary groups: intra-vehicle activities and extra-vehicle activities. Intra-vehicle activities are implemented in, at, or by the subject vehicle 10. Extra-vehicle activities involve apparatus outside of the vehicle 10, such as by communications being sent to other autonomous vehicles, plans to pick up a passenger or a timing for the pickup of a passenger that is not in the vehicle currently.

In some scenarios, the module(s) of the activity group 320 determine one or more intra-vehicle activities and one or more extra-activities to be performed together, such as by implementing a requested game in a subject vehicle, and sending a request to some of their friends sharing a ride in another autonomous vehicle.

Intra-vehicle activities are in various embodiments generated by the intra-vehicle-collaboration module 322, executed by the corresponding processing unit, and extra-vehicle activities are generated by the extra-vehicle-collaboration module 324, executed by the processing unit.

Determinations, in addition to informing present system outputs via the output group 330, can also be stored, in passenger or group profiles or otherwise, for use in future determinations, as indicated by the return arrow from the activity group 320 to the storage module 314.

### V.B.iii. Output Group 330

Modules of the output group 330 format, convert, or otherwise process output of the activity group 320 prior to delivering same to various output components—communication systems, autonomous driving systems, HVAC systems, infotainment systems, etc.

As shown, example system output components include vehicle speakers, screens, or other vehicle outputs 70.

Intra-vehicle activities, determined by the intra-vehicle collaboration module 322, are initiated via the intra-vehicle output module 332. Extra-vehicle activities, determined by the extra-vehicle collaboration module 324, are initiated via the extra-vehicle output module 334.

Example system output components can also include passenger mobile devices 34, such as smartphones, wearables, and headphones.

Example system output components can also include remote systems 50 such as remote servers and passenger computer systems (e.g., home computer). The output can be received and processed at these systems, such as to update a passenger profile with a determined preference, activity taken regarding the passenger, the like, or other.

Example system output components can also include a vehicle database. Output data can be provided to the database module 304, for instance, which can store such updates to an appropriate passenger account of the ancillary data 112.

Results of the output group 330, in addition to affecting present system function, can also be stored, in passenger or group profiles via the profiles-update module 336 or otherwise, for use in future determinations, as indicated by the return arrow from the output group 330 to the input group 310.

VI. Example Architecture

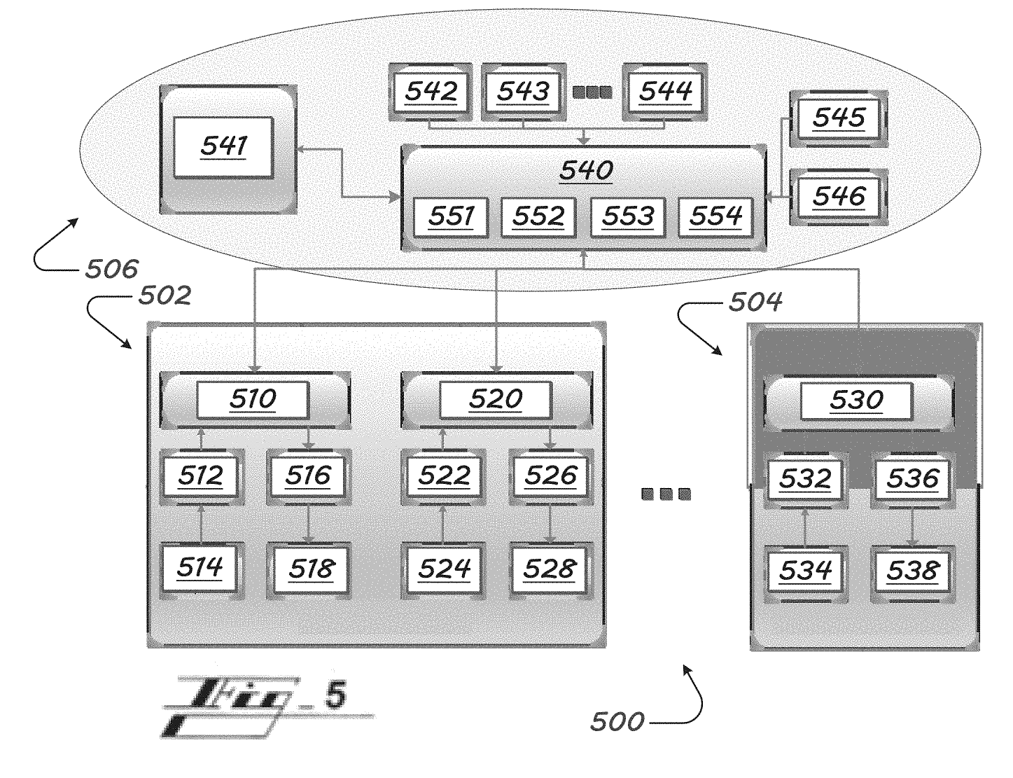

FIG. 5 shows schematically an example architecture 500 for use in performing functions of the present technology.

Any of the components of the architecture 500 can be part of, include, or work with the components of FIG. 4, for performing functions of the present technology.

In various embodiments, the architecture 500 includes primarily:
subject-vehicle components 502—user interface components;
other-vehicle(s) components 504—user interface components; and
shared-context manager system 506—includes or part of the components of the groups 310, 320, 330 of FIGS. 3 and 4—for instance, the context manager can correspond to the activity group 320 or parts thereof; user or group preferences or profiles 542, 543, 544 can correspond to the profiles mentioned in connection with the passenger and group profiles associated with the passenger-profiles learning module 316 and the group-profiles learning module 318.

### VI.A. Subject-Vehicle Components 502

Subject-vehicle components 502 include:
a first dialogue manager 510;
first passenger recognizer 512 (voice id, mobile device recognizer, facial recognition, password system, name recognition, etc.);
first passenger audio capture 514 (user interfacing via speech recognition or other communication modalities, even if not audio);
first passenger text-to-speech (TTS) 516;
first audio renderer 518 (determining what the passenger is communication, even if not via audio);
a second dialogue manager 520 (optional, as are other dialogue managers in the subject vehicle components 502);
a second dialogue manager 520 (optional, as are other dialogue managers in the subject vehicle components 502);
second passenger recognizer 522 (voice id, mobile device recognizer, facial recognition, password system, name recognition, etc.);
second passenger audio capture 524 (user interfacing via speech recognition or other communication modalities, even if not audio);
second passenger text-to-speech (TTS) 526;
second audio renderer 528 (determining what the passenger is communication, even if not via audio); and
While the example subject-vehicle components 502 illustrated have components for working with a first and a second passenger, the system can allot for a similar set for a third passenger and more;

### VI.B. Other-Vehicle Components 504

Other-vehicles can include the same components, e.g.:
Passenger (e.g., first passenger, of the second vehicle) dialogue manager 530;
Passenger recognizer 532 (voice id, mobile device recognizer, facial recognition, password system, name recognition, etc.);
Passenger audio capture 534 (user interfacing via speech recognition or other communication modalities, even if not audio);
Passenger text-to-speech (TTS) 536;
Audio renderer 538 (determining what the passenger is communication, even if not via audio); and
Other vehicles can have the same, such as each vehicle in a fleet of autonomous vehicles operated by an autonomous shared-vehicle or taxi vehicles.

### VI.C. Shared-Context Manager System 506

The shared-context manager (SCM) system 506 can be positioned in the first subject vehicle (associated with the first components 502), in a remote system, such as a server 50, in companion apps at passenger mobile devices, and/or in each subject vehicle—e.g., vehicles in an autonomous shared-vehicle or taxi fleet.

The shared-context manager system 506 in various embodiments includes:
a shared-context manager 540;
a companion app or interface to companion apps 541 (e.g., at passenger mobile device or interface to apps at mobile devices);
passenger or group preferences or profiles 542, 543 . . . 544 (n number of preferences or profiles, passenger or group profiles);
active-rides context component 545, having data indicating any of various relevant context, for instance, who is riding in which vehicle, an HVAC state, an infotainment state (e.g., current channel, volume, etc.), phone-related information, navigation information, etc.; and
reservation context component 546, having data indicating context regarding reservations, or rides generally, such as ride manifests, routes associated with groups, passengers, and vehicle(s), etc.

In various embodiments, the technology is configured to provide functions for sharing, between shared-ride users, functions related to any of various domains. Example sharing domains include audio, phone, gaming, and navigation.

The shared context manager 540 in various embodiments includes one or more modules or units to effect, facilitate, or manage the shared-ride operations described herein. Example units illustrated are an audio unit 551, a phone unit 552, a gaming unit 553, and a navigation unit 554, for performing operations described herein relating to audio, phone, gaming, and NAV, respectively.

Any of the units can be used to establish a shared-ride group, or other group. for instance, the audio-related functions may include establishing a group for sharing audio amongst users sharing a ride, such as in response to speech input requesting such grouping. The same applies for other functions, such regarding group phone functions, gaming functions, or navigation functions.

Other audio-related functions include effecting, facilitating, or managing sharing of the same audio between two or more users of a shared vehicle, or users of a group.

Other phone-related functions include effecting, facilitating, or managing sharing of phone calls between users of a shared vehicle, or users of a group.

Other game-related functions include effecting, facilitating, or managing gaming between users of a shared vehicle, or users of a group.

Other navigation functions include effecting, facilitating, managing, or arbitrating navigation needs of users of a shared vehicle, or users of a group.

The components can be implemented by various hardware and software. In various embodiments, any of the functions are performed by hardware embodiment such as a tablet or user phone being used by each or some of the passengers.

The tablet or a user phone may include an application configured to perform any of the functions described herein. The application may include, for instance, a dialog agent, which can perform functions like those described for the dialogue managers 510, 520, etc., or along with such dialogue managers 510, 520, etc.

In various embodiments, some or all speech recognition functions are performed at the vehicle system, at a user tablet, or at a cloud or remote-server system.

In one embodiment, the components and functions of the shared context manager 540 are split between any of the vehicle system, a user tablet/phone system, and a remote, e.g., server, system. The operations at multiple devices can be synchronized in any suitable manner.

VII. Use Cases

As mentioned, use cases are in various embodiments divided into two types: intra-vehicle-collaboration activities and extra-vehicle-collaboration activities.

Example use cases are as follows:

i) Intra-Vehicle-Collaboration (I.V.C.) Use Cases
(1) I.V.C. Use case 1
   (a) Laura: “Emma (vehicle nickname, or ‘car’), we would like to share our audio.”
   (b) Vehicle: “OK, playing the same audio in all speakers.”
(2) I.V.C. Use case 2
   (a) Laura: “Emma, do you have a game that all of us can share?”
   (b) Vehicle: “Sure, how about Mario Galaxy in shared mode?”
(3) I.V.C. Use case 3
   (a) Laura: “Emma, open (or ‘create’) a group for me, <passenger 2>, and <passenger 3>.”
   (b) Vehicle: “Ok, sharing your ride (or communications, etc.) with <passenger 2>, and <passenger 3>.”
(4) I.V.C. Use case 4
   (a) Laura: “Emma, put me in privacy mode.”
   (b) Vehicle: “Ok, privacy mode for you.”—Screens will not show personal information, acoustics in the car environment to be set to isolate person, spoken prompts will not contain personal preferences, etc.
(5) I.V.C. Use case 5
   (a) Laura: “Emma, you can drop off Bob first?”
   (b) Vehicle: “Sure, will take Bob first.”—audio presented in Bob & Laura's zones, e.g., seats of the vehicle, for instance.
(6) I.V.C. Use case 6
   (a) Laura: “Emma, can you drop me off before Bob?”
   (b) Vehicle: (Bob) “Bob, is it OK to drop Laura first, it will add 5 minutes?”
   (c) Bob: (to vehicle): “Sure, I can wait five minutes.”
   (d) Vehicle: “OK, dropping you off first.”

ii) Extra-Vehicle-Collaboration (E.V.C.) Use Cases
(1) E.V.C. Use case 1
   (a) Laura: “Emma, please call our next passenger we want to conference with him.
   (b) Vehicle: “OK, calling Dave in conferencing mode”
(2) E.V.C. Use case 2
   (a) Laura: “Emma, do you have a game that all of us in <group nickname>(including uses not in the vehicle with Laura) can play?”
   (b) Vehicle: “Sure, how about Mario Galaxy in shared server mode?”
(3) E.V.C. Use case 3
   (a) Laura: “Emma, I′d like to play ‘call of duty’ with the <particularly taxi-service>-game community”
   (b) Vehicle: “Sure, I′ll set it up for you” (can include non-passengers)

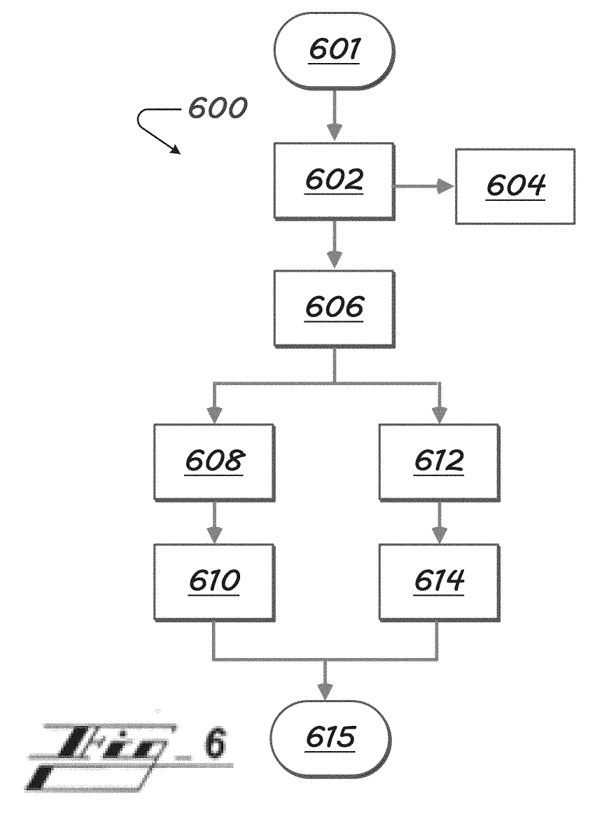

VIII. Second, Third, and Fourth Example Algorithms and Processes, for Effecting Group-Sharing Operations—FIGS. 6, 7, and 8

FIGS. 6-8 show various algorithms in the form of flow charts of operations for effecting operations of the present technology.

Though each chart shows the respective process as a single flow for simplicity, any of the functions or operations can be performed in one or more or processes, routines, or sub-routines of one or more algorithms, by one or more devices or systems.

It should be understood that the steps, operations, or functions of the processes 600, 700, 800 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes 600, 700, 800 can be ended at any time.

In certain embodiments, some or all operations of the processes 600, 700, 800 and/or substantially equivalent operations are performed by a computer processor, such as the hardware-based processing unit 106, executing computer-executable instructions stored on a non-transitory computer-readable storage device, such as any of the data storage devices 104, or of a mobile device, for instance, described above.

### VIII.A. Privacy Functions for one or more Shared-Ride Users

FIG. 6 shows a flow chart 600 including operations for effecting a privacy mode regarding users of a shared ride based on user speech.

The process commences 601 and flows to block 602, whereat the system, for instance, the vehicle system or a user tablet, receives voice input from a passenger P1 indicating a passenger desire to enter a privacy mode, such as by the user stating, “Emma, put me on privacy mode.” The scenario is like the fourth intra-vehicle use case provided (I.V.C. Use case 4) above.

The acting component can in this case be a dialogue manager DM1, like the DM 510, or a passenger tablet dialogue agent, communicating with the passenger P1 via the first passenger audio capture 514.

At block 604, a context module or other component of the system updates a system status to privacy mode in connection with the passenger P1.

A corresponding privacy mode can be implemented at various levels.

At block 606, an HMI controller or other component activates the privacy mode, or initiates the mode, in connection with the passenger P1.

At block 608, the dialogue manager DM1 or other component, such as the passenger tablet dialogue agent, activates a privacy mode in connection with the passenger P1.

At block 610, the dialogue module, or other component such as the passenger tablet dialogue agent, presents a communication to the passenger, confirming that the privacy mode has been entered for the passenger P1. The mode can include performing functions such as avoiding presentation of personal information in communications, such as screen and prompts regarding the passenger P1, whether communications to other passengers, users, and/or to the passenger P1. The latter case avoiding others seeing their personal information, for instance.

At block 612, the system, such as an audio and/or visual controller, activates private mode regarding any of various other privacy-related functions, such as phone, video calls, and automatic-speech recognition (ASR) zone activities regarding the passenger P1.

At block 614, the system, such as the audio and/or visual controller, performs the privacy-related function(s), such as delivering, or playing back, incoming calls, and any communications or prompts for the passenger P1, to a private zone in the vehicle, specific to the passengers. The private zone implementation may include, as just examples, provide communications only to a seat headrest speaker in a seat in which the passenger P1 is sitting, and perhaps a visual display specific to the passenger P1, such as a screen in front of and only visible to the passengers, whether a screen of the vehicle or a screen of a user device, like a tablet or phone.

The process can end 615 at any time, and any functions can be repeated.

### VIII.B. Phone Calling Amongst Shared-Ride Users

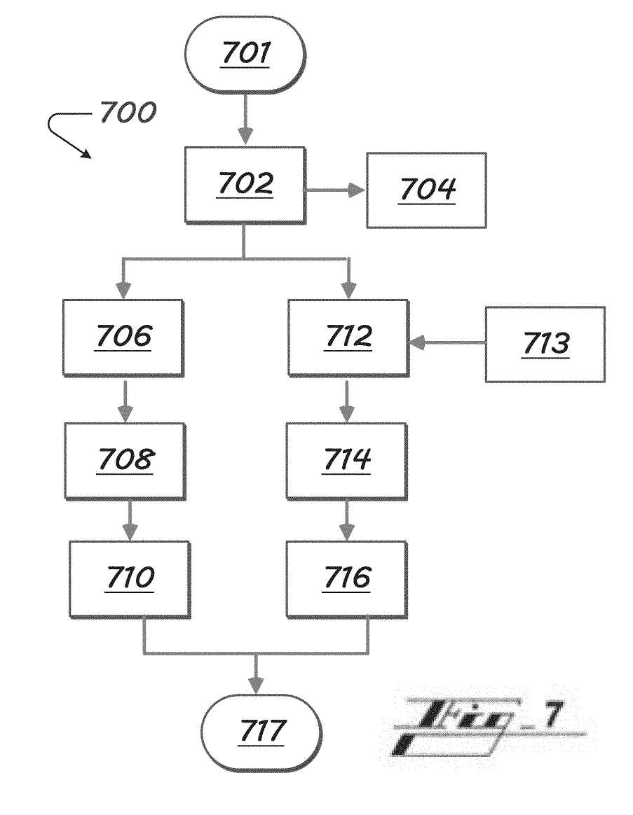

FIG. 7 shows a flow chart 700 including operations for effecting a conference call amongst users of a shared ride based on user speech.

The process commences 701 and flows to block 702, whereat the system, for instance, the vehicle system or a user tablet, receives voice input from a passenger P2 indicating a passenger desire to communicate with another user, who is to be a shared-ride rider, such as by stating, “Emma, please call our next passenger we want to conference with him.” The scenario is like the first extra-vehicle use case provided (E.V.C. Use case 1) above.

In various embodiments, a subject communication shared between group users is something other than a phone call, or along with a phone call. The communication can include, for instance, video data shared with a phone call, or by a video-call, a text message, files, or other data or media.

The acting component can in this case be the dialogue manager DM2,like the DM 520, or a second passenger P2 tablet dialogue agent, communicating with the passenger P2 via the second passenger audio capture 524.

At block 704, a shared context module (SCM) 540 or other component of the system checks settings or status regarding the next, arriving, passenger, such as a privacy setting corresponding to the other user.

A corresponding conference communication mode can be implemented at various levels.

At block 706, an HMI controller or other component activates the conference communication mode, or initiates the mode, in connection with at least the passenger P2, and in some embodiments with respect to multiple, to even all vehicle passengers.

At block 708, one or more the dialogue managers DM2 or other component, such as the second passenger P2 tablet dialogue agent, activates the conference communication mode in connection with the passenger P2. The operation may include activation of appropriate microphones, such as all vehicle microphones, to capture occupant voices.

At block 710, the audio and/or visual controller, or other component such as the passenger tablet dialogue agent, connects a call, or at least delivers communication from a connected call to one or more passengers via HMI, such as vehicle HMI and/or HMI of one or more user devices.

At block 712, the system, such as the dialogue manager(s) DM2 receives information about the next passenger. Information may be obtained, as indicated by input block 713, from a shared context manager 540 of the present vehicle or of a vehicle in which the next passenger is using, or from a remote server, as a few examples.

At block 714, the dialogue manager or other component initiates the call with the next passenger, presuming privacy settings for the other user does not prohibit the call.

At block 716, an audio and/or visual controller effects or maintains the call.

The process can end 717 at any time, and any functions can be repeated.

### VIII.C. Adjusting Itinerary of a Shared Ride

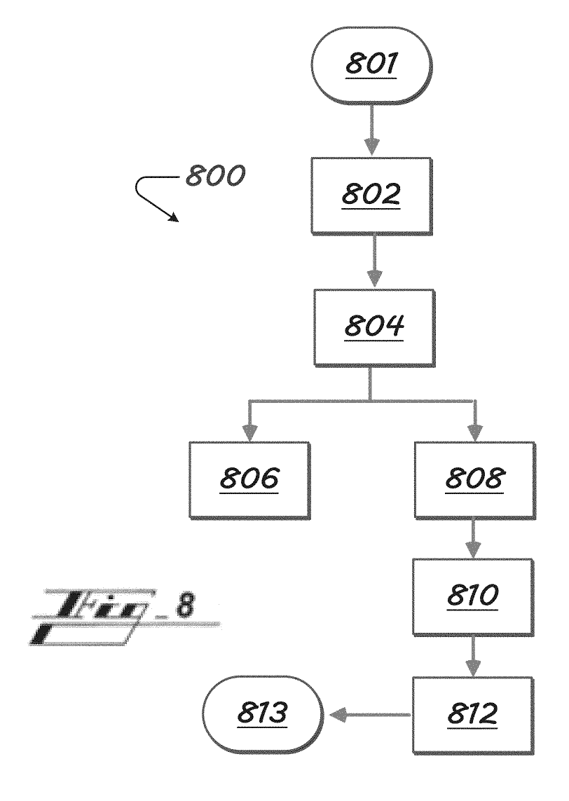

FIG. 8 shows a flow chart 800 including operations supporting users of a shared ride affecting ride itinerary by speech.

The process commences 801 and flows to block 802, whereat the system, for instance, the vehicle system or a user tablet, receives voice input from a passenger P1 indicating a passenger desire to change an itinerary for a shared ride, such as a shared autonomous vehicle. The passenger P1 may state, for instance, “Emma, can you drop me off before Bob?” The scenario is like the sixth intra-vehicle use case provided (I.V.C. Use case 6) above.

The acting component can in this case be the dialogue manager DM1,like the DM 510, or a first passenger P1 tablet dialogue agent, communicating with the passenger P1 via the second passenger audio capture 514.

At block 804, a shared context module (SCM) 540 or other component of the system reviews any of various ride data, such as data indicating status and itinerary of active rides, itinerary for planned rides, reservation contexts, and the like. Based on such data, the module 540 determines whether the change or detour proposed by the first passenger is possible or permitted.

If the change is not permitted, flow proceeds to block 806, whereat the dialogue module 540 initiates communication to the requesting passenger, advising that the change is not possible, such as by audio advising, “I′m sorry, <passenger name>, right now the change cannot be made because <reason>.”

At block 808, if the change is permitted, a second dialogue manager DM2, associated with the second passenger (Bob in the example) asks the second passenger for agreement to the change—such as, “Bob, is it OK to drop Laura first? It will add 5 minutes to your ride.” The second passenger response is obtained—e.g., Bob states, “Sure, I can wait 5 minutes.” The dialogue module receives and processes the response.

At block 810, the SCM 540 or other component updates ride data accordingly, such as updating active rides and reservations contexts, for at least the first and second passengers P1, P2. In various embodiments, the updating includes updating passenger profiles, such as updating first and second profiles corresponding to the first and second passengers P1, P2. the function may be performed by the mentioned profiles-update module 336. The module 336 is in various embodiments a part of, includes, or works with the SCM 540. The update to the profile for the second passenger P2 may indicate any aspect of the circumstances, such as, here, that he accepted a slightly longer ride to assist a passenger. For the first passenger P1, the update may indicate that the first passenger P1 prefers to arrive early, or to have shorter commute times on certain days, or feels comfortable changing places with another passenger in a ride itinerary, or at least under specified circumstances or context. The preferences may be generated as part of machine learning and/or results can be used by such system learning to improve subsequent operation of the system, whether at the same vehicle. Learning functions can be performed by the passenger-profiles learning module 316 mentioned, which may be a part of, include, or work with the SCM 540. The learning may be performed at a server, or results are sent to the server, for improving later interactions involving one of both passengers in connection with a ride they are taking or planning to take. The SCM 540 in various embodiments sends a message to one or more of the dialogue managers DM1, DM2, for advising corresponding passengers.

At block 812, the dialogue manager(s) DM1, etc., advises the passenger(s) P1, such as by advising, “Laura, you will be dropped off first.”

The process can end 813 at any time, and any functions can be repeated.

IX. Select Advantages

Many of the benefits and advantages of the present technology are described above. The present section restates some of those and references some others. The benefits described are not exhaustive of the benefits of the present technology.

Systems of the present technology are configured to provide services customized to autonomous-vehicle passengers or users, who are part of groups (which can be created ad hoc, arranged explicitly by the passengers, or established by the system based on learning), resulting in a high-quality experiences. The passengers may be users whether actually in a vehicle at the time services are being offered. The passenger may be preparing to meet the vehicle, soon, for instance.

As another example benefit, by the learning functions, the vehicle is customized better for autonomous-vehicle passengers and groups, and the passenger experience is improved. As an example, passenger are more comfortable, and experience less or no stress, as the vehicle makes more decisions based on determined passenger and group preferences, requests, instructions, and actions, in any of a wide variety of contexts.

Autonomous-vehicle passengers or users are also relieved of having to determine how, or it is much easier to, advise the vehicle of what the passenger, or the group, wants. They need not, for instance, consider which button to press, or which exact pre-scripted, or pre-set, control wording to say.

The technology in operation enhances autonomous-vehicle passengers' satisfaction, including comfort, with using automated driving by adjusting any of a wide variety of vehicle and/or non-vehicle characteristics, such as vehicle driving-style parameters.

The technology will lead to increased automated-driving system use. Passengers or users, whether yet a passenger, are more likely to use or learn about more-advanced autonomous-driving capabilities of the vehicle as well.

A ‘relationship’ between the passenger(s) and a subject vehicle can be improved—the passenger will consider the vehicle as more of a trusted tool, assistant, or friend.

The technology can also affect levels of adoption and, related, affect marketing and sales of autonomous-driving-capable vehicles. As passengers' trust in autonomous-driving systems increases, they are more likely to purchase an autonomous-driving-capable vehicle, purchase another one, or recommend, or model use of, one to others.

Another benefit of system use is that users will not need to invest effort in setting or calibrating automated driver style parameters, as they are set or adjusted automatically by the system, to minimize user stress and therein increase user satisfaction and comfort with the autonomous-driving vehicle and functionality.

X. Conclusion

Various embodiments of the present disclosure are disclosed herein.

The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface is referenced, for example, the referenced surface can, but need not be vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for determining autonomous-driving-vehicle actions associated with a group of autonomous-driving-vehicle passengers, comprising:
a hardware-based processing unit; and
a non-transitory computer-readable storage device comprising:
an input-interface module that, when executed by the processing unit, obtains, from at least a first autonomous-driving-vehicle passenger of the group of autonomous-driving-vehicle passengers, an autonomous-vehicle-passenger input relating to the group; and
an intra-vehicle-collaboration module that, when executed by the processing unit, determines, based on the autonomous-vehicle-passenger input, a function to be performed at the vehicle.

2. The system of claim 1 wherein the intra-vehicle-collaboration module, when executed by the processing unit, determines the vehicle function based on the autonomous-vehicle-passenger input and passenger-group-profile data.

3. The system of claim 2 further comprising a group-profiles learning module that, when executed by the processing unit, determines the group-profile data.

4. The system of claim 3 wherein the group-profiles learning module, when executed by the processing unit, determines the group-profile data based on one or more prior observations of, or communications with, passengers in the group.

5. The system of claim 1 wherein the intra-vehicle-collaboration module, when executed by the processing unit, determines the vehicle function based on the autonomous-vehicle-passenger input and passenger-profile data.

6. The system of claim 5 further comprising a passenger-profiles learning module that, when executed by the processing unit, determines the passenger-profile data.

7. The system of claim 6 wherein the passenger-profiles learning module, when executed by the processing unit, determines the passenger-profile data based on one or more prior observations of, or communications with, the first autonomous-driving-vehicle passenger.

8. The system of claim 1 further comprising an intra-vehicle output module that, when executed by the processing unit, initiates the vehicle function determined.

9. The system of claim 8 wherein the vehicle function determined includes initiating a privacy mode at the vehicle for the first passenger.

10. The system of claim 8 wherein the vehicle function determined includes initiating an audio-sharing session between the first passenger and another passenger of the group of passengers.

11. The system of claim 8 wherein the vehicle function determined includes initiating a shared game to be played by the first passenger and another passenger of the group.

12. The system of claim 8 wherein the vehicle function determined includes determining a change to vehicle navigation or itinerary affecting the first passenger and another passenger of the group.

13. The system of claim 8 wherein the vehicle function determined includes a phone call between the first passenger and another passenger of the group.

14. The system of claim 13 wherein the other passenger is not in the vehicle when the phone call is established.

15. A system, for determining autonomous-driving-vehicle actions associated with a group of autonomous-driving-vehicle passengers, comprising:
a hardware-based processing unit; and
a non-transitory computer-readable storage device comprising:
an input-interface module that, when executed by the processing unit, obtains, from at least a first autonomous-driving-vehicle passenger of the group of autonomous-driving-vehicle passengers, an autonomous-vehicle-passenger input relating to the group; and
an extra-vehicle-collaboration module that, when executed by the processing unit, determines, based on the autonomous-vehicle-passenger input, a function to be performed at least in part outside of the vehicle.

16. The system of claim 15 wherein the extra-vehicle-collaboration module, when executed by the processing unit, determines the vehicle function based on the autonomous-vehicle-passenger input and passenger-group-profile data.

17. The system of claim 16 further comprising a group-profiles learning module that, when executed by the processing unit, determines the group-profile data.

18. The system of claim 15 wherein the extra-vehicle-collaboration module, when executed by the processing unit, determines the appropriate vehicle function based on the autonomous-vehicle-passenger input and passenger-profile data.

19. The system of claim 18 further comprising a passenger-profiles learning module that, when executed by the processing unit, determines the passenger-profile data.

20. A system, for determining autonomous-driving-vehicle actions associated with a group of autonomous-driving-vehicle passengers, comprising:
a hardware-based processing unit; and
a non-transitory computer-readable storage device comprising:
an input-interface module that, when executed by the processing unit, obtains, from at least a first autonomous-driving-vehicle passenger of the group of autonomous-driving-vehicle passengers, an autonomous-vehicle-passenger input relating to the group; and
at least one collaboration module selected from a group of collaboration modules consisting of:
an extra-vehicle-collaboration module that, when executed by the processing unit, determines, based on the autonomous-vehicle-passenger input, a function to be performed at least in part outside of the vehicle; and
an intra-vehicle-collaboration module that, when executed by the processing unit, determines, based on the autonomous-vehicle-passenger input, a function to be performed at the vehicle.
